(19) United States
(12) Patent Application Publication
(10) Pub. No.: US 2025/0102720 A1
(43) Pub. Date: Mar. 27, 2025

(54) LIGHT GUIDE MEMBER AND BACKLIT MODULE

(71) Applicant: Darfon Electronics Corp., Taoyuan City (TW)

(72) Inventor: Yuchuan Ku, Taoyuan City (TW)

(21) Appl. No.: 18/899,071

(22) Filed: Sep. 27, 2024

Related U.S. Application Data
(60) Provisional application No. 63/540,936, filed on Sep. 27, 2023.

(30) Foreign Application Priority Data
Sep. 26, 2024 (TW) 113136779

(51) Int. Cl. F21V 8/00; G06F 3/0354

(52) U.S. Cl. CPC G02B 6/002; G02B 6/0088; G02B 6/0091; G06F 3/03543

(57) ABSTRACT

A backlit module includes a light guide member and a light source. The light guide member includes a body having a first side and a second side opposite to each other, a light input surface disposed on the first side of the body, a light output surface disposed at an end of the body opposite to the light input surface, and a curved surface disposed on the second side of the body and corresponding to the light input surface, wherein a vertical projection of the light input surface overlaps the curved surface, and the light source is disposed corresponding to the light input surface and the curved surface.

### CROSS-REFERENCE TO RELATED APPLICATION

This application claims the priority benefits of Taiwan patent application serial No. 113136779, filed on Sep. 26, 2024, and also claims the priority benefits of U.S. provisional application Ser. No. 63/540,936, filed Sep. 27, 2023. The entirety of the mentioned above patent applications is hereby incorporated by reference herein and made a part of this specification.

### BACKGROUND OF THE INVENTION

### 1. Field of the Invention

The invention generally relates to a light guide member. Particularly, the invention relates to a light guide member having a curved surface and a backlit module having the light guide member.

### 2. Description of the Prior Art

Conventional mouse devices usually have characters or patterns that represent brands or trademarks disposed on the cover of the mouse device. By disposing the light source on the upper surface of the circuit board, light can be directly emitted toward the cover to achieve the lighting performance of illuminating characters or patterns. However, with the increasing diversity in appearance design, when the characters or patterns of the mouse device are placed near the bottom side at the rear side, since the circuit board is usually placed parallel to the bottom side of the mouse device, the emitted upward or downward light cannot be utilized sufficiently to illuminate the characters or patterns near the bottom side at the rear side of the mouse device.

### SUMMARY OF THE INVENTION

It is an object of the invention to provide a light guide member, which has a curved surface disposed at an opposite side of the light input surface and configured to reflect light at a wide angle range in the transverse direction.

In an embodiment, the invention provides a light guide member, which includes a body having a first side and a second side opposite to each other, a light input surface disposed on the first side of the body, a light output surface disposed at an end of the body opposite to the light input surface, and a curved surface disposed on the second side of the body and corresponding to the light input surface, wherein a vertical projection of the light input surface overlaps the curved surface.

In another embodiment, the invention provides a backlit module, which includes a light guide member and a light source. The light guide member includes a body having a first side and a second side opposite to each other, a light input surface disposed on the first side of the body, a light output surface disposed at an end of the body opposite to the light input surface, and a curved surface disposed on the second side of the body and corresponding to the light input surface. The light source is disposed corresponding to the light input surface and the curved surface wherein light emitted from the light source enters the light guide member from the light input surface, and the curved surface is configured to reflect the light entering the light guide member toward the light output surface.

In an embodiment, in a plane view, the curved surface extends toward the light output surface in a sector shape.

In an embodiment, the light guide member further includes a reflective layer disposed on the curved surface.

In an embodiment, the light guide member further includes a groove disposed in the body and adjacent to the curved surface.

In an embodiment, the body includes a plurality of fins disposed along a periphery of the body; the light output surface is disposed on the plurality of fins.

In an embodiment, an upper surface of each of the plurality of fins is raised up with respect to the light input surface and parallel to the light input surface.

In an embodiment, each of the plurality of fins has an inclined surface; the inclined surface is inclined from a distal end of the fin toward the curved surface.

In an embodiment, the body has a plane surface at the first side; a tangent plane parallel to the plane surface defines a portion of the curved surface closest to the plane surface; the light input surface is a part of the plane surface and located between the portion of the curved surface and the light output surface.

In an embodiment, a light emitting surface of the light source is disposed adjacent to the portion of the curved surface.

In an embodiment, the light input surface and the light output surface are respectively disposed at a light input end and a light output end of the light guide member; a light emitting direction of the light source crosses a light propagation direction from the light input end to the light output end.

In yet another embodiment, the invention provides a backlit module, which includes a light guide member and a plurality of light sources. The light guide member includes a body having a first side and a second side opposite to each other, a light input surface disposed on the first side of the body, a light output surface disposed at an end of the body opposite to the light input surface, a plurality of curved surfaces disposed on the second side of the body and corresponding to the light input surface, and a groove disposed between two adjacent curved surfaces of the plurality of curved surfaces. The plurality of light sources are disposed on the light input surface and correspond to the plurality of curved surfaces, respectively.

In an embodiment, two adjacent light sources of the plurality of light sources disposed corresponding to two adjacent curved surfaces of the plurality of curved surfaces provide complementary colors of light.

Compared with the prior art, the light guide member of the invention has a curved surface, which is configured to reflect light at a wide angle range to a greater distance in the transverse direction. Moreover, the light guide member of the invention can output light in multiple directions with the output surface in the form of fins to enhance the lighting effect.

### BRIEF DESCRIPTION OF THE DRAWINGS

FIG. 1 is a schematic perspective view of the mouse device in an embodiment of the invention.

FIG. 2 is a schematic cross-sectional view of the rear portion of the mouse device of FIG. 1.

FIG. 3 is a schematic perspective view of the light guide member in an embodiment of the invention viewing from the top.

FIG. 4 is a schematic perspective view of the light guide member of FIG. 3 viewing from the bottom.

FIG. 5 is a plane view of the light guide member of FIG. 3.

FIG. 6 is a schematic cross-sectional view of the light guide member in an embodiment.

FIGS. 7 and 8 are schematic perspective views of the rear portion of the mouse device without the rear cover in an embodiment of the invention viewing from the top and the bottom, respectively.

FIGS. 9 and 10 are schematic perspective views of the rear portion of the mouse device without the rear cover in another embodiment of the invention viewing from the top and the bottom, respectively.

FIGS. 11 to 13 are schematic plane views of the backlit module in different embodiments.

### DETAILED DESCRIPTION OF THE PREFERRED EMBODIMENT

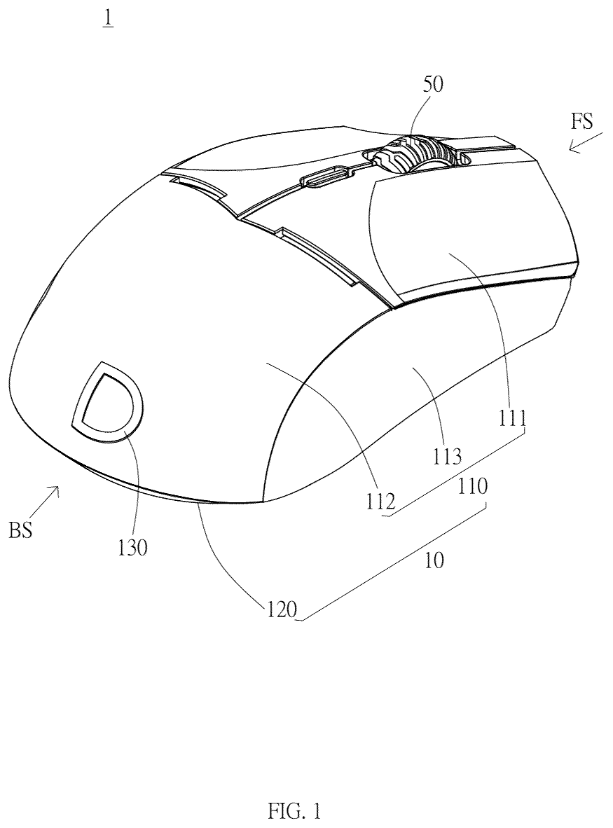

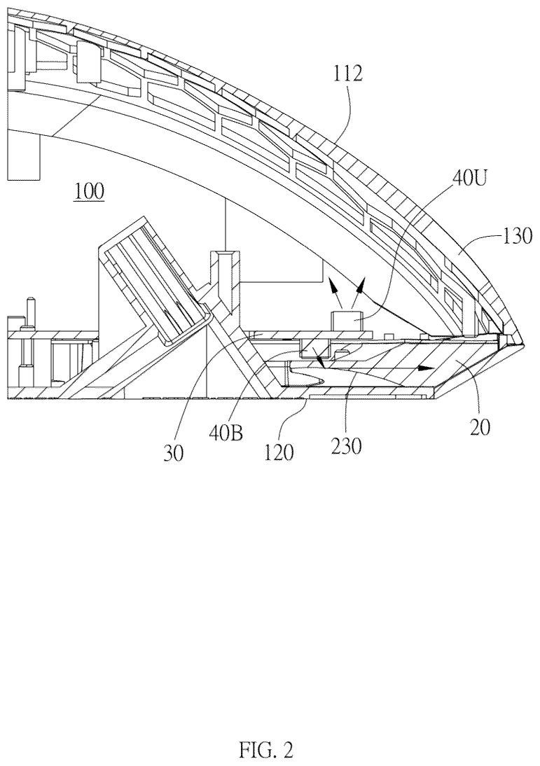

The invention mainly involves a light guide member having a cured surface and a backlit module and an electronic device having the light guide member, wherein the curved surface of the light guide member is designed to reflect light at a wide angle range in the transverse direction to improve the lighting effect. Referring to FIG. 1 and FIG. 2, FIG. 1 is a schematic perspective view of the mouse device in an embodiment of the invention, and FIG. 2 is a schematic cross-sectional view of the rear portion of the mouse device of FIG. 1. It is noted that FIG. 1 illustrates the mouse device as the input device or electronic device, but not limited thereto. Any electronic device employing the light guide member of the invention falls within the scope of the invention. As shown in FIG. 1 and FIG. 2, in an embodiment, the mouse device 1 includes a housing 10, a light guide member 20, a circuit board 30, and light sources 40U, 40B. The housing 10 includes an upper casing 110 and a lower casing 120. The upper casing 110 and the lower casing 120 are combined with each other to define an accommodation space 100 therein. The accommodation space 100 is configured to accommodate components of the mouse device 1, such as the circuit board 30, the light source 40U/40B, the light guide member 20, the wheel 50, keyswitch units (not shown). In an embodiment, the upper casing 110 may include a front cover 111, a rear cover 112, and side covers 113. In this embodiment, the mouse device 1 is defined according to the positions of the fingers and the palm when operating to have a front side FS and a rear side BS. For example, the front side FS is a side of the mouse device 1 that is closer to the fingers, and the rear side BS is another side of the mouse device 1 that is closer to the palm. The front cover 111 and the rear cover 112 are disposed at the front side FS and the rear side BS, respectively. Two side covers 113 are disposed at two sides (e.g. left and right sides) of the mouse device 1 and configured to connect the front cover 111 and the rear cover 112 to the lower casing 120, but not limited thereto. According to practical applications, the front cover 111, the rear cover 112 and/or two side covers 113 of the upper casing 110 can be integrated to reduce the amount of components and enhance the appearance design. For example, the front cover 111 and the rear cover 112 can be integrated into a single cover, which is connected to the lower casing 120 by means of the side covers 113. Alternatively, the upper casing 110 can be an integral casing including the front cover 111, the rear cover 112, and the side covers 113. The mouse device 1 has a light permeable portion 130. The light permeable portion 130 is disposed at the rear side BS near the lower casing 120, such as at the lower portion of the rear cover 112. In an embodiment, the light permeable portion 130 can be in the form of characters and/or patterns. The lower casing 120 can be a base of the mouse device 1 and provided with supporting/positioning structures for mounting, fixing or positioning the components of the mouse device 1.

As shown in FIG. 2, the circuit board 30 is preferably disposed in the accommodation space 100 and located parallel to the lower casing 120. In other words, the extending directions of the circuit board 30 and the lower casing 120 are substantially parallel. In an embodiment, the circuit board 30 can be a flexible printed circuit board, but not limited thereto. A plurality of light sources (e.g. upper light source 40U and lower light source 40B) can be disposed on the upper surface and the lower surface of the circuit board 30, respectively, and electrically connected to the circuit board 30 to receive the power for driving the light sources 40U, 40B to emit light. The light source is preferably a top emitting light source with 50% or more light emitted from the top surface, but not limited thereto. For example, the light source can be a light-emitting diode (LED), mini LED, micro LED, which may have a configuration of single chip or multiple chips. According to practical applications, the light source can be a side emitting light source, and the light source can be optionally disposed only on the lower surface of the circuit board 30 and not disposed on the upper surface of the circuit board 30, e.g. only the lower light sources 40B provided. The light source 40U disposed on the upper surface of the circuit board 30 emits light upward to directly illuminate the light permeable portion 130 of the rear cover 112. The light source 40B disposed on the lower surface of the circuit board 30 emits light downward, and then travels in the transverse direction through the light guide member 20 to a greater distance and illuminates the light permeable portion 130. In this embodiment, the light guide member 20 is disposed under the circuit board 30 (or the light source 40B), and the extending direction (or light propagation direction) of the light guide member 20 is substantially parallel to the circuit board 30. The light guide member 20 has a curved surface 230, so that after light emitted from the light source 40B, which is disposed below the circuit board 30, enters the light guide member 20, the curved surface 230 is configured to reflect the light entering the light guide member 20 in the transverse direction to a greater distance. Hereinafter, the light guide member 20 of the invention and the backlit module BL including the light guide member 20 will be described in detail.

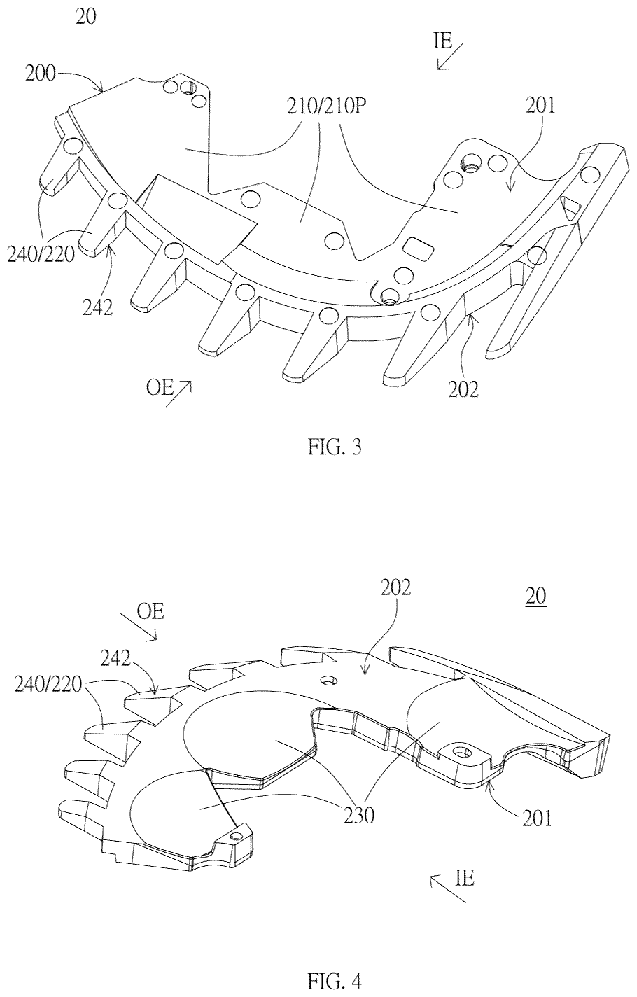

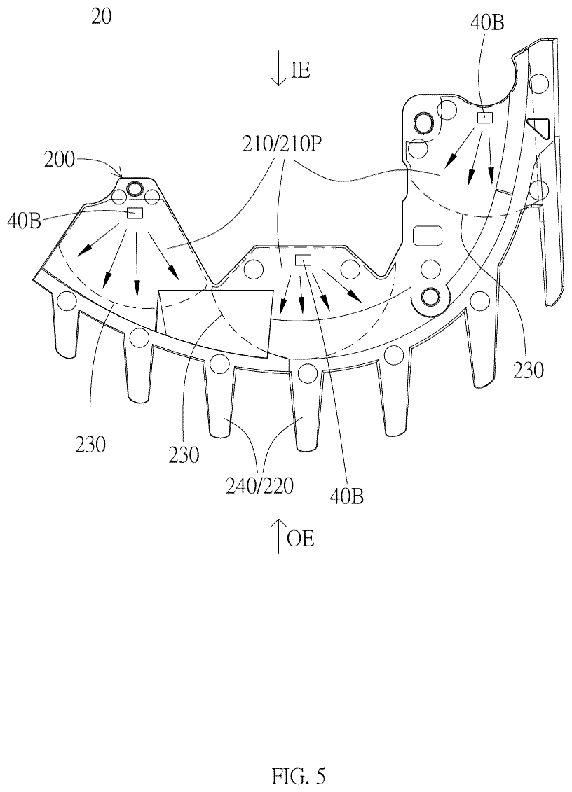

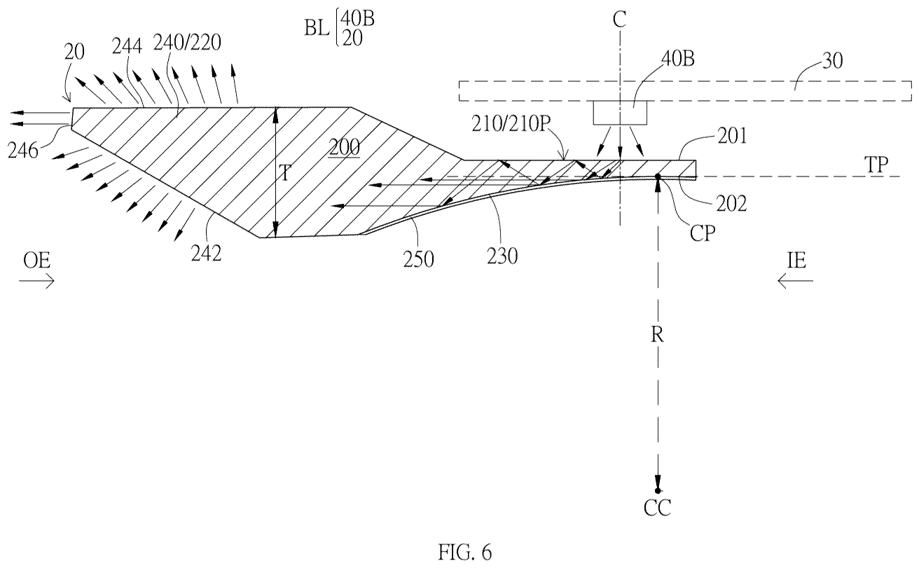

Referring to FIG. 3 to FIG. 6, FIG. 3 is a schematic perspective view of the light guide member in an embodiment of the invention viewing from the top; FIG. 4 is a schematic perspective view of the light guide member of FIG. 3 viewing from the bottom; FIG. 5 is a plane view of the light guide member of FIG. 3; FIG. 6 is a schematic cross-sectional view of the light guide member in an embodiment.

As shown in FIG. 3 to FIG. 6, the light guide member 20 includes a body 200, a light input surface 210, a light output surface 220, and a curved surface 230. The body 200 has a first side 201 and a second side 202 opposite to each other, such as upper side and lower side. The light input surface 210 is disposed on the first side 201 (e.g. upper side) of the body 200. The light output surface 220 and the light input surface 210 are respectively disposed at two opposite ends of the body 200, such as light output end OE and light input end IE. The curved surface 230 is disposed on the second side 202 (e.g. lower side) of the body 200 and corresponds to the light input surface 210. The vertical projection of the light input surface 210 overlaps the curved surface 230.

Specifically, the light guide member 20 (or the body 200) can be made of any suitable optical material, such as polycarbonate (PC), polymethyl methacrylate (PMMA), polystyrene (PS), but not limited thereto. In this embodiment, the body 200 of the light guide member 20 preferably has an outline corresponding to the lower casing 120 at the rear side BS, such as a curved outline. The light input surface 210, the light output surface 220, and the curved surface 230 are surfaces of corresponding portions of the body 200. For example, the light input surface 210 and the light input end IE are located adjacent to the inner curved side of the body 200. The light output surface 220 and the light output end OE are located adjacent to the outer curved side of the body 200. In an embodiment, the light input surface 210 preferably does not overlap the light output surface 220. The curved surface 230 is located under the light input surface 210 and between the light input end IE and the light output end OE. The body 200 may further include a plurality of fins 240. The plurality of fins 240 are disposed along the periphery of the body 200, and the light output surface 220 is disposed on the plurality of fins 240. In other words, the light output end OE of the light guide member 20 can be designed as the plurality of fins 240, which extend radially, so that light emitted from the light source 40B can be propagated in the light guide member 20 and then emitted out from the plurality of fins 240, but not limited thereto. As shown in the drawings, the body 200 is provided with seven fins 240, but not limited thereto. According to practical applications, the body 200 may include more than seven or less than seven fins, or even no fins.

In an embodiment, the body 200 preferably has a plane surface 210P at the first side 201, and the light input surface 210 is a part of the plane surface 210P. For example, the upper surface of the body 200 is preferably the plane surface 210P, so that the part of the upper surface of the body 200 that is closer to the light input end IE can function as the light input surface 210. As shown in FIG. 5, the plane surface 210P of the body 200 extends from the light input end IE toward the light output end OE, and the light input surface 210 is preferably the part of the plane surface 210P that is adjacent to the light input end IE. The curved surface 230 is disposed at one side (e.g. lower side) of the body 200 opposite to the light input surface 210, so that the light input surface 210 and the curved surface 230 overlap in the thickness direction of the body 200. From another aspect, the vertical projection of the curved surface 230 on the upper surface of the body 200 at least partially overlaps the light input surface 210. For example, in this embodiment, three curved surfaces 230 are disposed on the lower side of body 200 along the curved outline of the body 200 to correspond to three light input surfaces 210 on the upper side of the body 200, but not limited thereto. According to practical applications, the amount of the curved surface 230 (or the light input surface 210) can be less than or more than three. As shown in FIG. 4 and FIG. 5, in the plane view, the curved surface 230 may extend toward the light output surface 220 in a sector shape, and the vertical projection of the curved surface 230 preferably does not overlap the light output surface 220. For example, the vertical projection of the curved surface 230 does not overlap the plurality of fins 240. According to the light output requirements, the curvature and the area of sector of the plurality of curved surfaces 230 can be the same or different. From another aspect, in the plane view, the curved surface 230 extends radially toward the light output surface 220 in the horizontal direction, so that light also travels radially from the curved surface 230 in the horizontal direction. Accordingly, the curved surface 230 can reflect light to the light output surface 220 in a wide horizontal angle range, allowing the light to travel a greater distance in the transverse direction. Outside two boundary lines of the curved surface 230, such as the straight lines at two sides of the sector, light is less propagated in the transverse direction. Accordingly, by controlling the area of sector of the curved surface 230, such as by controlling the central angle of the sector or the side length of the sector, the traveling direction of light can be modulated.

In an embodiment, as shown in FIGS. 4 and 6, the curved surface 230 can be considered as an inner surface of a cup, which is recessed into the lower surface of the body 200. The curved surface 230 is designed to reflect light at a wide angle range toward a greater distance in the transverse direction. Accordingly, the portion of the body 200 with the curved surface 230 can be referred as a reflective cup. For example, the curved surface 230 can be a single curved surface or a double curved surface, which has a lower curvature. For example, the curvature of the curved surface 230 can be determined based on the thickness of the light guide member 20 (or the body 200), the distance with the light output surface 220, etc. Herein, the thickness of the light guide member 20 refers to the largest distance/thickness between the first side 201 and the second side 202 (e.g. between the upper surface and the lower surface) of the body 200. For example, as shown in FIG. 6, when the thickness T of the light guide member 20 is 2 mm, the radius of curvature R of the curved surface 230 (e.g. the distance from the center of curvature CC to the curved surface 230) is preferably 5˜20 mm, so that the curved surface 230 has a total reflection effect at angles of about 40˜65 degrees, facilitating the control of the amount of light output. When the thickness T of the light guide member 20 is 3 mm, the radius of curvature R of the curved surface 230 is preferably 10˜30 mm, so that the curved surface 230 has a total reflection effect at angles of about 40˜65 degrees, facilitating the control of the amount of light output. When the thickness T of the light guide member 20 is 4 mm, the radius of curvature R of the curved surface 230 is preferably 10˜30 mm, so that the curved surface 230 has a total reflection effect at angles of about 40˜65 degrees, facilitating the control of the amount of light output. When the thickness T of the light guide member 20 is 5 mm, the radius of curvature R of the curved surface 230 is preferably 10˜30 mm, so that the curved surface 230 has a total reflection effect at angles of about 40˜70 degrees, facilitating the control of the amount of light output. From another aspect, the radius of curvature R of the curved surface 230 is preferably about 2˜10 times of the thickness T of the light guide member 20, but not limited thereto. According to practical applications, the radius of curvature R of the curved surface 230 can be less than 2 times of the thickness T of the light guide member 20 or larger than 10 times of the thickness T of the light guide member 20.

Moreover, as shown in FIGS. 3 and 6, the upper surface 244 of each of the fins 240 is preferably raised up with respect to the light input surface 210, and the upper surface 244 of the fin 240 is preferably parallel to the light input surface 210. Each of the fins 240 preferably has an inclined surface 242. The inclined surface 242 is inclined from the distal end of the corresponding fin 240 toward the curved surface 230. For example, the inclined surface 242 can be inclined from the end surface 246 of the fin 240 toward the light input end IE. In an embodiment, the surface of the fin 240 (e.g. the upper surface 244, the inclined surface 242, and the end surface 246) can function as the light output surface 220, so that light can be emitted out of the light guide member 20 from various directions (e.g. upper side, lower side, rear end) to enhance the lighting effect. Light emitted from the light source 40B can enter the light guide member 20 (or the body 200) from the light input surface 210; then, the curved surface 230 is configured to reflect the light entering the light guide member 20 toward the fins 240. Light is approximately totally reflected at the fins 240 in the left-right transverse direction and then emitted out from the upper surfaces 244, the inclined surfaces 242, and the end surfaces 246 of the fins 240.

Moreover, as shown in FIG. 6, the tangent plane TP which is parallel to the plane surface 210P (or the light input surface 210) at the first side 201 of the body 200 defines a portion CP of the curved surface 230 that is closest to the plane surface 210P. The light input surface 210 is preferably located between the portion CP of the curved surface 230 closest to the plane surface 210P and the light output surface 220. For example, the closest portion CP of the curved surface 230 is substantially the portion of the body 200 that has the smallest thickness, and the closest portion CP can be a line or a point. For example, when the curved surface 230 is a single curved surface, the closest portion CP can be a line on the curved surface 230. When the curved surface 230 is a double curved surface, the closest portion CP can be a point on the curved surface 230. From another aspect, the center C of the light source 40B is preferably located between the portion CP of the curved surface 230 closest to the plane surface 210P and the light output surface 220. With such a configuration, the curved surface 230 can reflect most of light to the light output end OE, and only less or almost no light is reflected from the curved surface 230 toward the light input end IE. From another aspect, the portion CP of the curved surface 230 closest to the plane surface 210P can be a most recessed point of the curved surface 230 at the second side 202 (e.g. lower side), which is defined by the normal to the plane surface 210P that passes the center of curvature CC of the curved surface 230. Herein, the most recessed point of the curved surface 230 refers to the deepest portion recessed from the lower surface of the body 200. As shown in FIG. 5, a plurality of light sources 40B are disposed on the light input surface 210 and correspond to the plurality of curved surfaces 230, respectively. Each light source 40B is preferably disposed on the light input surface 210 corresponding to the curved surface 230 near the light input end IE. In an embodiment, the vertical projection of the light source 40B preferably does not overlap the portion CP of the curved surface 230 closest to the plane surface 210P. The light emitting direction of the light source 40B crosses the light propagation direction of the light guide member 20 from the light input end IE to the light output end OE. For example, the light source 40B substantially emits light downward, and the light propagation direction of the light guide member 20 is substantially a transverse (or lateral) direction. With the curved surface 230, the downward light entering the light guide member 20 can be reflected to the light output surface 220 in the transverse direction, such as the left side in FIG. 5.

In addition, as shown in FIG. 6, the light guide member 20 may further include a reflective layer 250. The reflective layer 250 is disposed on the curved surface 230. The reflective layer 250 is configured to reflect light that leaks from the lower side of the body 200 back to the light guide member 20, facilitating the recycle of light and the increase in amount of light output. In an embodiment, the reflective layer 250 can be a reflective coating formed by coating reflective material(s) (e.g. white paint or white ink) on the curved surface 230, but not limited thereto. In other embodiments, the reflective layer 250 can be a reflective film made of reflective materials (e.g. metal foil), a layer of reflective material coated on a non-reflective film, or a plastic film doped with reflective particles (e.g. polyethylene terephthalate film (PET) doped with reflective particles). In another embodiment (not shown), the lower casing 120 can be provided with a reflective bump at a location corresponding to the curved surface 230, and the reflective bump has a shape complementary to the reflective cup, facilitating the effects of recycling light and increasing the amount of light output.

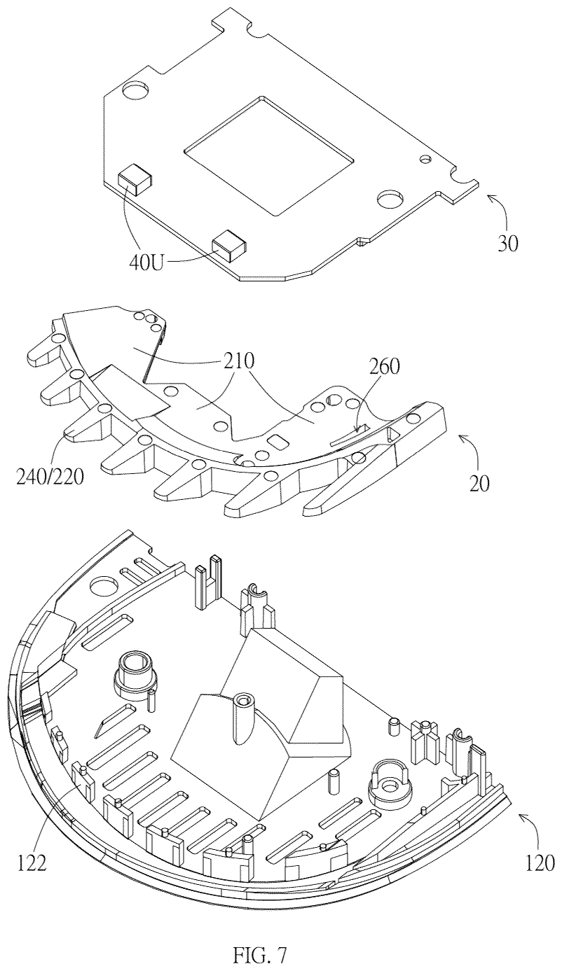

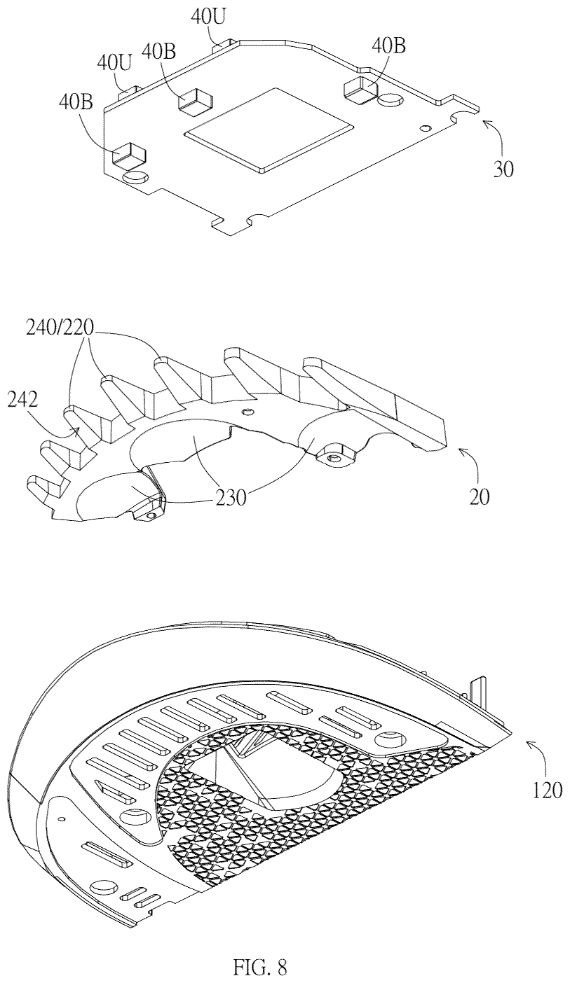

Referring to FIGS. 7 and 8, FIGS. 7 and 8 are schematic perspective views of the rear portion of the mouse device without the rear cover in an embodiment of the invention viewing from the top and the bottom, respectively. As shown in FIGS. 7 and 8, corresponding to the plurality of fins 240 of the light guide member 20, the lower casing 120 preferably has a plurality of positioning portions 122. The plurality of positioning portions 122 protrude upward from the lower casing 120 and are disposed along the periphery of the lower casing 120 with spacings corresponding to the width of the fins 240. When the light guide member 240 is disposed on the lower casing 120, each fin 240 can extend through the corresponding spacing between the positioning portions 122 to achieve the positioning effect. Moreover, in this embodiment, the light guide member 20 can further include a groove 260. The groove 260 can be disposed adjacent to the curved surface 230. The sidewall of the groove 260 can be configured to reflect light, so that with the arrangement of the groove 260, the traveling direction of light can be modified. The groove 260 can be a groove that penetrates through the entire thickness of the body 200 or extends into the body 200 by a certain depth. The depth or width of the groove 260 can determine the amount of light output, and the shape of the groove 260 can determine the traveling direction of light.

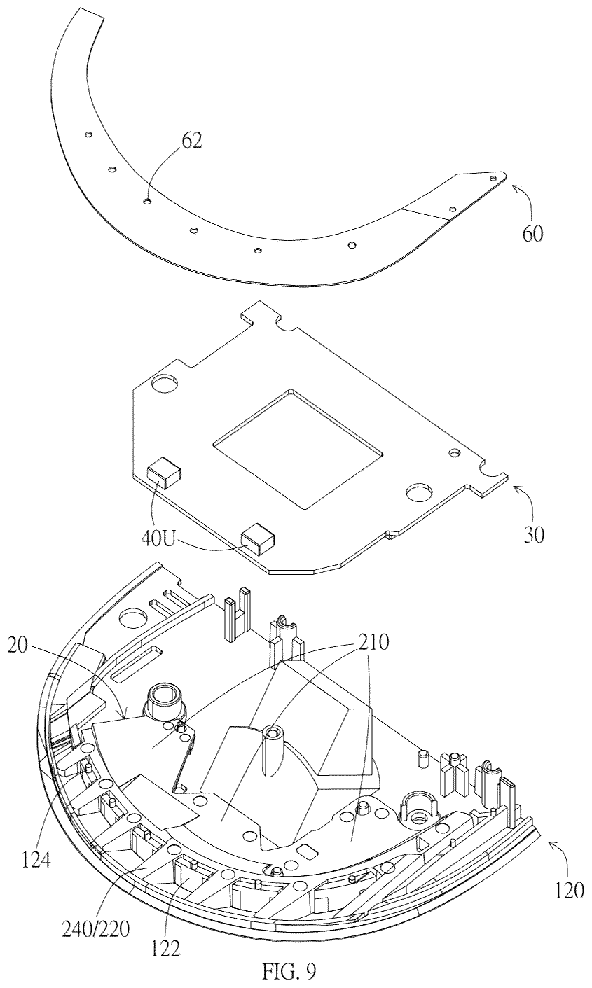

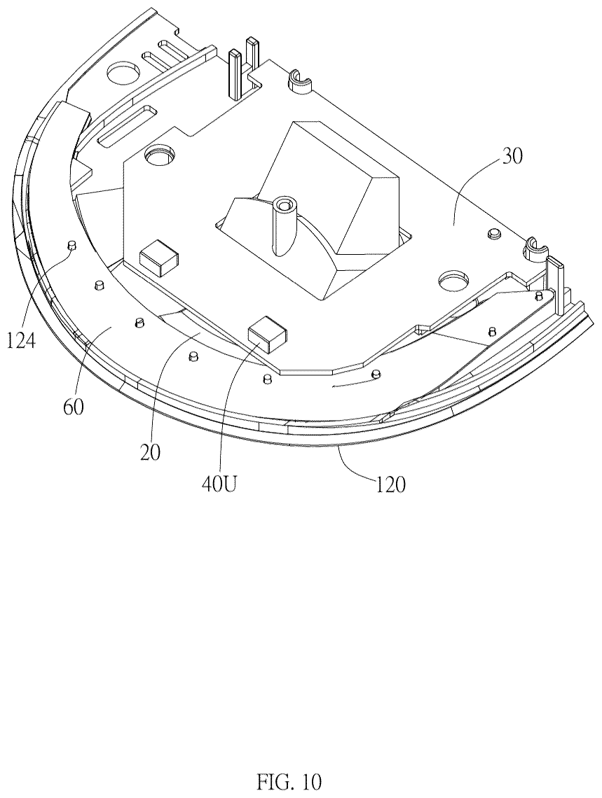

Referring to FIGS. 9 and 10, FIGS. 9 and 10 are schematic perspective views of the rear portion of the mouse device without the rear cover in another embodiment of the invention viewing from the top and the bottom, respectively. As shown in FIGS. 9 and 10, the backlit module of the invention can optionally have a mask film 60. The mask film 60 can block (absorb or reflect) light emitted out of the light guide member 20. For example, in this embodiment, the mask film 60 is configured to block the upward light from the light guide member 20. The mask film 60 has a curved outline corresponding to the plurality of fins 240 of the body 200, and the mask film 60 has a plurality of positioning holes 62. Corresponding to the positioning holes 62 of the mask film 60, the lower casing 120 has a plurality of positioning pins 124. The positioning pins 124 are preferably disposed on the positioning portions 122. When the light guide member 20 is positioned on the lower casing 120 by the positioning portions 122, the mask film 260 is positioned on the plurality of fins 240 by inserting the positioning pins 124 into the positioning holes 62.

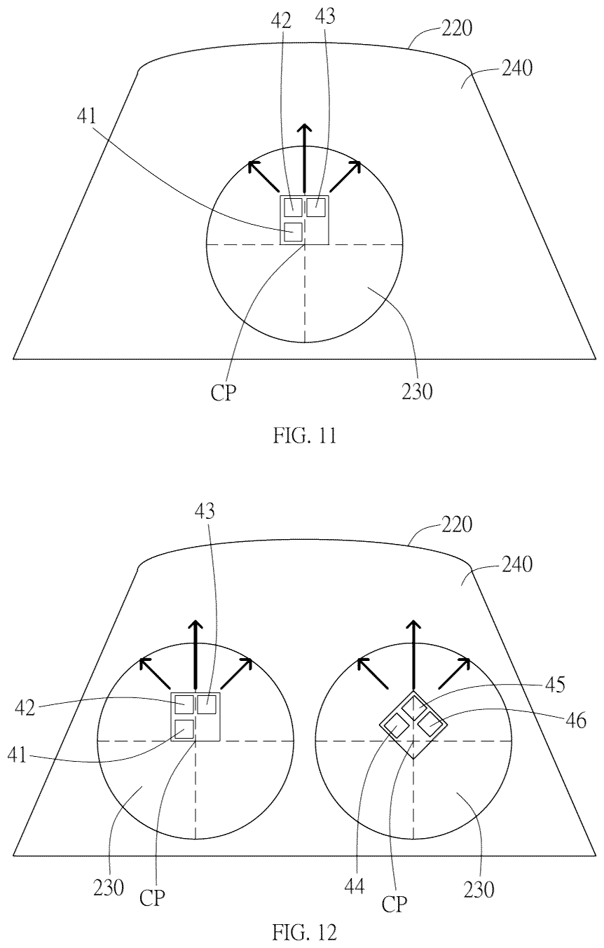

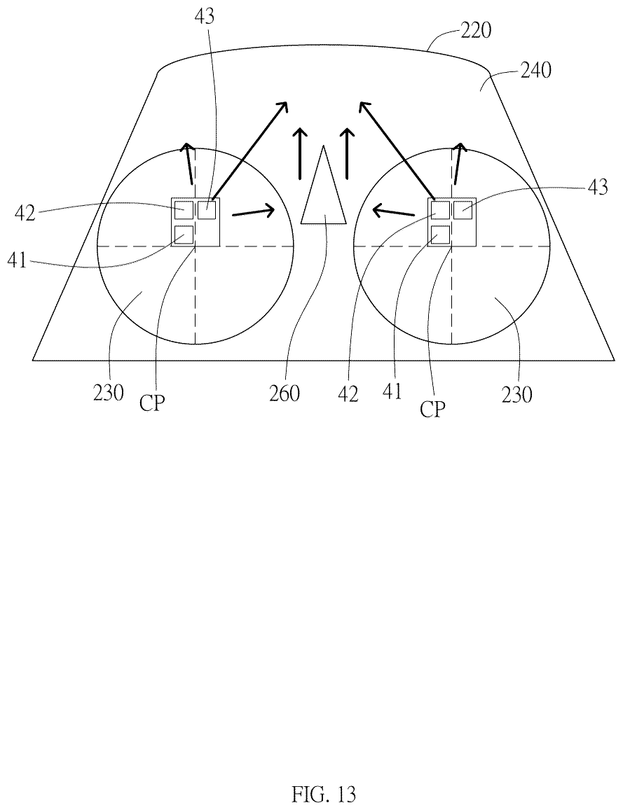

Referring to FIGS. 11 to 13, FIGS. 11 to 13 are schematic plane views of the backlit module in different embodiments. As shown in FIG. 11, when the single fin 240 corresponds to only one set of the light source 40B and the reflective cup (i.e., the curved surface 230), the curved surface 230 is preferably located at the longitudinal central line of the fin 240 or at the neighborhood of the longitudinal central line of the fin 240. The light source 40B is preferably disposed at the central line of the light output surface 220 or the curved surface 230. When the curved surface 230 has an asymmetric shape, the light source 40B is preferably disposed deviating from the central line of the curved surface 230, but not limited thereto. In this embodiment, the light source 40B includes three chips 41, 42, 43, and the three chips 41, 42, 43 can emit the same color or different colors of light. In an embodiment, the three chips 41, 42, 43 preferably emit red, green, and blue colors of light, respectively, but not limited thereto.

As shown in FIG, 12, the single fin 240 corresponds to multiple sets of the light source 40B and the reflective cup (i.e., the curved surface 230). When the light output ranges of adjacent two sets of the light source 40B and the curved surface 230 overlap with each other, two adjacent light sources 40B which are disposed corresponding to the two adjacent curved surfaces 230 preferably provide complementary colors of light. For example, the three chips 41, 42, 43 of the light source 40B at the left side preferably emit red, green, and blue colors of light, respectively. The three chips 44, 45, 46 of the light source 40B at the right side preferably emit red, green, and blue colors of light, respectively. The light source 40B at the right side preferably rotates 45 degrees, so that the chip 44 emitting the red color of light is adjacent to the chip 43 emitting the blue color of light, facilitating the effect of mixing light.

As shown in FIG, 13, the single fin 240 corresponds to multiple sets of the light source 40B and the reflective cup (i.e., the curved surface 230). The groove 260 is preferably disposed between adjacent curved surfaces 230 to isolate the light output ranges. With the reflection of light from the sidewall of the groove 260, lights from adjacent light sources 40B can be prevented from mixing to enhance the expression of colors.

Although the preferred embodiments of the invention have been described herein, the above description is merely illustrative. The preferred embodiments disclosed will not limit the scope of the invention. Further modification of the invention herein disclosed will occur to those skilled in the respective arts and all such modifications are deemed to be within the scope of the invention as defined by the appended claims.

What is claimed is:

1. A light guide member, comprising:
a body having a first side and a second side opposite to each other;
a light input surface disposed on the first side of the body;
a light output surface disposed at an end of the body opposite to the light input surface; and
a curved surface disposed on the second side of the body and corresponding to the light input surface,
wherein a vertical projection of the light input surface overlaps the curved surface.

2. The light guide member of claim 1, wherein in a plane view, the curved surface extends toward the light output surface in a sector shape.

3. The light guide member of claim 1, further comprising a reflective layer disposed on the curved surface.

4. The light guide member of claim 1, further comprising a groove disposed in the body and adjacent to the curved surface.

5. The light guide member of claim 1, wherein the body comprises a plurality of fins disposed along a periphery of the body; the light output surface is disposed on the plurality of fins.

6. The light guide member of claim 5, wherein an upper surface of each of the plurality of fins is raised up with respect to the light input surface and parallel to the light input surface.

7. The light guide member of claim 5, wherein each of the plurality of fins has an inclined surface; the inclined surface is inclined from a distal end of the fin toward the curved surface.

8. The light guide member of claim 1, wherein the body has a plane surface at the first side;
a tangent plane parallel to the plane surface defines a portion of the curved surface closest to the plane surface; the light input surface is a part of the plane surface and located between the portion of the curved surface and the light output surface.

9. A backlit module, comprising:
a light guide member, comprising:
a body having a first side and a second side opposite to each other;
a light input surface disposed on the first side of the body;
a light output surface disposed at an end of the body opposite to the light input surface; and
a curved surface disposed on the second side of the body and corresponding to the light input surface; and
a light source disposed corresponding to the light input surface and the curved surface,
wherein light emitted from the light source enters the light guide member from the light input surface, and the curved surface is configured to reflect the light entering the light guide member toward the light output surface.

10. The backlit module of claim 9, wherein in a plane view, the curved surface extends toward the light output surface in a sector shape; a vertical projection of the curved surface does not overlap the light output surface.

11. The backlit module of claim 9, wherein the light guide member further comprises a reflective layer disposed on the curved surface.

12. The backlit module of claim 9, wherein the light guide member further comprises a groove disposed in the body and adjacent to the curved surface.

13. The backlit module of claim 9, wherein the body comprises a plurality of fins disposed along a periphery of the body; the light output surface is disposed on the plurality of fins.

14. The backlit module of claim 13, wherein an upper surface of each of the plurality of fins is raised up with respect to the light input surface and parallel to the light input surface.

15. The backlit module of claim 13, wherein each of the plurality of fins has an inclined surface; the inclined surface is inclined from a distal end of the fin toward the curved surface.

16. The backlit module of claim 9, wherein the body has a plane surface at the first side; a tangent plane parallel to the plane surface defines a portion of the curved surface closest to the plane surface; the light input surface is a part of the plane surface and located between the portion of the curved surface and the light output surface.

17. The backlit module of claim 16, wherein a light emitting surface of the light source is disposed adjacent to the portion of the curved surface.

18. The backlit module of claim 9, wherein the light input surface and the light output surface are respectively disposed at a light input end and a light output end of the light guide member; a light emitting direction of the light source crosses a light propagation direction from the light input end to the light output end.

19. A backlit module, comprising:
a light guide member, comprising:
a body having a first side and a second side opposite to each other;
a light input surface disposed on the first side of the body;
a light output surface disposed at an end of the body opposite to the light input surface;
a plurality of curved surfaces disposed on the second side of the body and corresponding to the light input surface; and
a groove disposed between two adjacent curved surfaces of the plurality of curved surfaces; and
a plurality of light sources disposed on the light input surface and corresponding to the plurality of curved surfaces, respectively.

20. The backlit module of claim 19, wherein two adjacent light sources of the plurality of light sources disposed corresponding to two adjacent curved surfaces of the plurality of curved surfaces provide complementary colors of light.
